(19) United States
(12) Patent Application Publication
(10) Pub. No.: US 2002/0100197 A1
(43) Pub. Date: Aug. 1, 2002

(54) Emergency indicator

(76) Inventor: Joe B. Perry, Mineola, TX (US)

Correspondence Address: DUNLAP, CODDING & ROGERS P.C., PO BOX 16370, OKLAHOMA CITY, OK, 73114, US

(21) Appl. No.: 09/770,563

(22) Filed: Jan. 26, 2001

(51) Int. Cl. G09F 15/00

(52) U.S. Cl. 40/606

(57) ABSTRACT

An emergency indicator to be placed outside of a residence or business during emergency situations in order to facilitate emergency personnel, such as ambulance, fireman or police, in locating the particular residence or business in need of emergency services, as well as methods for using same. The emergency indicator includes a mounting frame and an information display member containing the indication of an emergency situation by having the numerals “911” affixed thereon. Shown beneath “911” is the address or name of the residence or business in need of emergency services. The emergency information can consist of numbers and/or letters and can be constructed from a reflective material.

### CROSS REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention relates generally to locator devices, and more particularly, but not by way of limitation, to emergency indicators which facilitate emergency personnel in locating a residence or business in need of emergency services. In one aspect, the present invention relates to methods for signaling for assistance in an emergency by noticeably displaying “911” and the address of the building having the emergency.

2. Brief Description of Related Art

Alarm systems are useful for summoning assistance in emergency situations, and many alarm systems are known in the art. Alarm systems typically include sirens, lighted displays and/or flashing lights. However, alarm systems can be expensive to produce and contain multiple parts, such as bulbs and batteries, which can malfunction and/or need to be replaced at certain time intervals. In addition, alarm systems are typically mounted and fixed to a visible portion of a building or in front of such building. As such, alarm systems may be unsightly and affect the overall appearance of the building, which may be undesirable to the occupant of the building. In addition, alarm systems may require some direction in usage, and a person experiencing an emergency may have trouble remembering how to activate the alarm system.

Therefore, there is a need felt within the art for an inexpensive emergency indicator which is portable and removable as well as simple and easy to use. It is to such an emergency indicator that the present invention is directed.

### SUMMARY OF THE INVENTION

The present invention is directed to an emergency indicator for identifying the location of an emergency. Broadly, the emergency indicator includes a frame and a display panel connected to the frame. The frame has a lower end and an upper end. The lower end is adapted to be disposed in the ground so as to support the frame in a substantially upright position. The upper end of the frame defines a panel receiving space.

The display panel is positioned in the panel receiving space and is connected to the frame. The display panel has an upper display area having a width and a lower display area having a width. The width of the upper display area is less than the width of the lower display area. The upper display area has an indicia indicative of an emergency situation displayed on at least one surface thereof, and the lower display area has an indicia indicative of the location of the emergency situation displayed in conjunction with the indicia displayed on the upper display area so that the indicia is visible to emergency personnel being informed that an emergency exists at the location of the emergency indicator.

In another aspect, the present invention is directed to a method for indicating the location of an emergency situation with an emergency indicator. The emergency indicator includes a frame and a display panel. The frame has a lower end and an upper end with the lower end adapted to be disposed in the ground so as to support the frame in a substantially upright position and the upper end of the frame defining a panel receiving space. The display panel is positioned in the panel receiving space and connected to the frame. The display panel has an upper display area and a lower display area with the upper display area having an indicia indicative of an emergency situation displayed on at least one surface thereof and the lower display area having an indicia indicative of the location of the emergency situation displayed in conjunction with the indicia displayed on the upper display area. The lower end of the frame is inserted into the ground at a location where the indicia of the upper display area and the indicia of the lower display area are visible to emergency personnel upon emergency personnel being informed that a emergency exists at the location designated by the emergency indicator.

Other features and advantages of the present invention will become apparent from the following detailed description when read in conjunction with the accompanying drawings and claims.

### BRIEF DESCRIPTION OF THE DRAWINGS

FIG. 1 is a front perspective view of an emergency indicator constructed in accordance with the present invention.

FIG. 2 is a rear elevational view of the emergency indicator of FIG. 1.

FIG. 3 is a front elevational view of a portion of the emergency indicator.

### DETAILED DESCRIPTION OF THE INVENTION

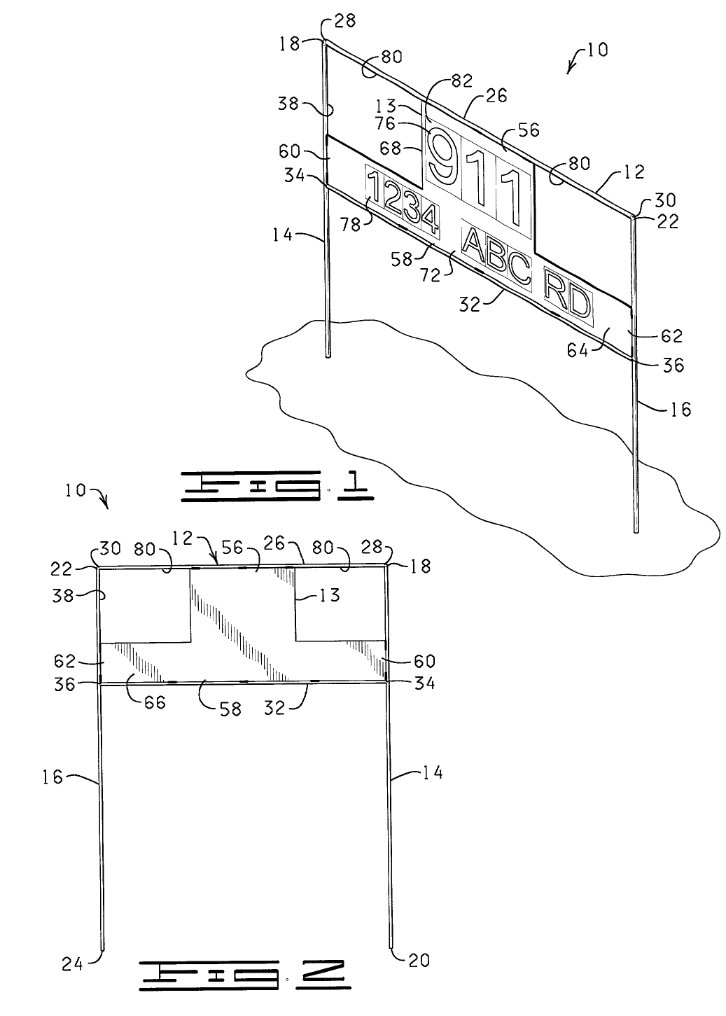

Turning now to the drawings, FIGS. 1-3 illustrate an emergency indicator 10 constructed in accordance with the present invention. The emergency indicator 10 is a sign capable of being easily placed outside of a residence or business prior to or during emergency situations in order to facilitate emergency personnel, such as an ambulance, fireman or police, in locating the particular residence or business in need of emergency services. Broadly, the emergency indicator 10 includes a frame 12 and a display panel 13 supported by the frame 12.

The frame 12 includes a pair of vertical support members, referred to herein as a first support member 14 and a second support member 16. The first support member 14 has a first end 18 and a second end 20, while the second support member 16 has a first end 22 and a second end 24. The first support member 14 and the second support member 16 are disposed in a substantially parallel configuration relative to each other such that the second end 20 of the first support member 14 and the second end 24 of the second support member 16 are positionable in the ground for supporting the frame 12 in a substantially upright position. The first and second support members 14 and 16 of the frame 12 should be provided with substantially the same length.

The frame 12 further includes an upper cross member 26 having a first end 28 and a second end 30 and a lower cross member 32 having a first end 34 and a second end 36. Preferably, the upper and lower cross members 26 and 32 are substantially the same length. However, it is to be understood that the lower cross member 32 may be substantially longer or substantially shorter than the upper cross member 26, or alternatively, the lower cross member 32 may be omitted. The upper cross member 26 is desirably substantially the same length as the distance between the first and second support members 14 and 16 such that the first end 28 of the upper cross member 26 is connected to the first end 18 of the first support member 14 in a substantially perpendicular relationship, and the second end 30 of the upper cross member 26 is connected to the first end 22 of the second support member 16 in a substantially perpendicular relation.

When provided, the lower cross member 32 is desirably substantially the same length as the distance between the first and second support members 14 and 16 such that the first end 34 of the lower cross member 32 is connected to the first support member 14 at a position between the first and second ends 18 and 20 thereof in a substantially perpendicular relationship, and the second end 36 of the lower cross member 32 is connected to the second support member 16 at a position between the first and second ends 22 and 24 thereof in a substantially perpendicular relationship. As such, a portion of the first and second support members 14 and 16, the upper cross member 26, and the lower cross member 32 cooperate to define a panel receiving space 38. The above-described connections between the first and second support members 14 and 16 and the upper and lower cross members 26 and 32 of the mounting frame 12 may be formed by any method known in the art, including weld, ties, clamps and combinations thereof.

The frame 12 can be constructed from any material of sufficient rigidity and strength to allow the emergency indicator 10 formed therefrom to function in accordance with the present invention as described in detail herein. Generally, the frame 12 may be constructed of metal, wood, plastic and combinations thereof. The thickness of the material from which the mounting frame 12 is constructed may vary, as long as the emergency indicator 10 formed therefrom functions in accordance with the present invention. In a preferred embodiment, the frame 12 is constructed of steel rods having a thickness of about 3/16 inch in diameter.

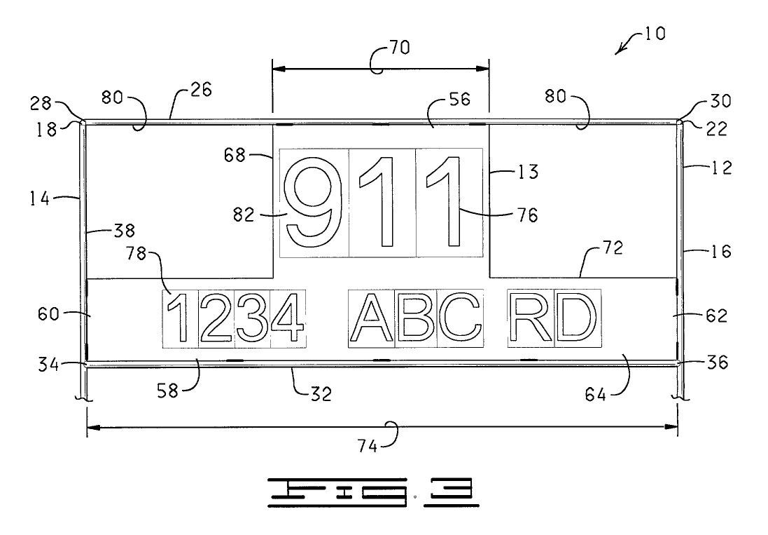

The display panel 13 has a substantially inverted T-shaped configuration and has sufficient surface area to provide emergency information thereon. The display panel 13 has an upper end 56, a lower end 58, a first side 60, a second side 62, a front surface 64 (FIGS. 1 and 3), and a rear surface 66 (FIG. 2). The display panel 13 is positioned over or within the panel receiving space 38 of the frame 12 and is connected to the frame 12 so as to support the display panel 13 in a stable condition relative to the frame 12 and therefore provide for maximum visibility of emergency information (described below) displayed on the display panel 13. The display panel 13 can be constructed from any material of sufficient rigidity and strength to allow the emergency indicator 10 formed therefrom to function in accordance with the present invention as described in detail herein. The display panel 13 is preferably constructed of a sheet metal, but the display panel 13 may also be constructed of wood, plastic and combinations thereof. The thickness of the material from which the display panel 13 is constructed may vary, as long as the emergency indicator 10 formed therefrom functions in accordance with the present invention. The above-described connections between the frame 12 and the display panel 13 may be formed by any method known in the art, including weld, ties, clamps and combinations thereof.

As mentioned above, the display panel 13 has a substantially inverted T-shaped configuration. To this end, the display panel 13 is provided with an upper display area 68 having a width 70 and a lower display area 72 having a width 74, as shown in FIG. 3. The width 74 of the lower display area 72 is greater than the width 70 of the upper display area 68. The upper display area 68 of the display panel 13 is designated to receive only indicia 76 indicative of an emergency situation, such as the numbers “911”, thereby causing such indicia to stand out. The lower display area 72 is designated to receive indicia 78 indicative of the location of the emergency situation, such as the name and/or address of the building where the emergency is located. The lower display area 72 may include additional indicia, such as indicia alerting emergency personnel as to a specific medical condition. The indicia 76 indicative of an emergency is preferably provided in a font larger in size than the indicia 78 indicative of the location to further cause the indicia 76 to stand out relative to other indicia on the display panel 13.

As further shown in FIGS. 1-3, the width 70 of the upper display area 68 being less than the width 74 of the lower display area 72 defines a pair of openings 80 which facilitate gripping of the emergency indicator 10 during transport and insertion into and removable from the ground.

The indicia 76 and 78 should be of a sufficient size to permit someone to clearly view and distinctly read the letters and/or numbers of the indicia 76 and 78 from a location removed from the emergency location, such as from a vehicle approaching the emergency location. In a preferred embodiment, the indicia 76 and 78 will preferably be constructed of a material having reflective characteristics, such that the indicia 76 and 78 will be visible at night. The indicia 76 and 78 may be applied to the display panel 13 by painting the indicia 76 and 78 onto the display panel 13 or by selectively applying suitable stickers 82 (as illustrated in FIGS. 1 and 3 where only one of the stickers is designated) which contain individual letters and/or numbers to the display panel 13 so as to form the indicia 76 and 78.

The frame 12 is depicted herein as having a substantially rectangular configuration. However, it will be understood that the frame 12 could have any configuration, such as triangular, and is not limited to the embodiments described herein. For example, when an emergency indicator comprises a frame having a substantially triangular configuration, the frame will be similar to the frame 12 described herein but will not include the upper cross member 26 and the display panel 13 will extend away from an upper end of the triangular frame.

The emergency indicator 10 may be constructed to be any size and shape so long as the frame 12 and the display panel 13 of the emergency indicator 10 are connectable as described hereinabove, and so long as the emergency indicator 10 so formed functions in accordance with the present invention as described herein.

However, by way of example only, the frame 12 may have a height of about 24 inches and a width of about 18 inches. The display panel 13 may have an overall height of about 7 inches and an overall width of about 18 inches. The upper display area 68 of the display panel 13 may have a height of about 4½ inches and a width of about 6½ inches, while the lower display area 72 of the display panel 13 may have a height of about 2½ inches and a width of about 18 inches.

In one method of use of the present invention, the emergency indicator 10 is provided and stored in an inconspicuous but readily available location in a business or residence until ready for use. This location should be somewhere that a person experiencing an emergency can easily recall and have immediate access to when the emergency indicator 10 is needed. An individual then removes the emergency indicator 10 from such location and disposes the emergency indicator 10 in a highly visible location outside of the residence or business. This location will often be adjacent to the driveway of the property where the emergency is taking place. The emergency indicator 10 is then secured in such position by positioning the second end 20 of the first support member 14 of the frame 12 and the second end 24 of the second support member 16 of the frame 12 in the ground. The indicia 76 and 78 are then clearly visible and can be distinctly read from a distance, thereby enabling an emergency vehicle, such as a police car, fire truck or ambulance, and emergency personnel to quickly locate the residence or business. Upon the conclusion of the emergency situation, the emergency indicator 10 can be removed from the ground and returned to its storage location.

In another method of use, the emergency indicator 10 is positioned in a highly visible location, such as adjacent to the driveway, prior to an emergency occurring and left there permanently so that the indicia 76 and 78 are visible to emergency personnel upon emergency personnel being informed that an emergency exists at the location designated by the emergency indicator 10.

Changes may be made in the construction and the operation of the various components, elements and assemblies described herein or in the steps or the sequence of steps of the methods described herein without departing from the spirit and scope of the invention as defined in the following claims.

What is claimed is:

1. An emergency indicator for enabling emergency personnel to locate the site of an emergency situation, comprising:
a frame having a lower end and an upper end, the lower end adapted to be disposed in the ground so as to support the frame in a substantially upright position, the upper end of the frame defining a panel receiving space; and
a display panel positioned in the panel receiving space and connected to the frame, the display panel having an upper display area having a width and a lower display area having a width, the width of the upper display area being less than the width of the lower display area, the upper display area having an indicia indicative of an emergency situation displayed on at least one surface thereof and the lower display area having an indicia indicative of the location of the emergency situation displayed in conjunction with the indicia displayed on the upper display area so that the indicia is visible to emergency personnel that have been informed that an emergency exists at the location of the emergency indicator.

2. The emergency indicator of claim 1 wherein the frame includes a pair of spaced apart vertical support members and at least one cross member extending between the vertical support members, the display panel positioned relative to the cross member such that the display panel and the frame define a pair of openings which facilitate gripping of the frame during transport and insertion into and removal from the ground.

3. The emergency indicator of claim 2 wherein the frame further comprises another cross member extending between the support members in a parallel, spaced apart relationship relative to the other cross member, the panel receiving space in which the display panel is positioned is defined by the cross members and a corresponding portion of each of the vertical support members.

4. The emergency indicator of claim 1 wherein the indicia indicative of the emergency and the indicia indicative of the location of the emergency are formed by stickers selectively applied to the display panel.

5. The emergency indicator of claim 1 wherein the indicia indicative of the emergency and the indicia indicative of the residence or business are constructed of a reflective material.

6. The emergency indicator of claim 1 wherein the indicia indicative of the emergency is 911.

7. The emergency indicator of claim 1 wherein the indicia indicative of the location of the emergency situation is an address or name of such site.

8. The emergency indicator of claim 1 wherein the emergency indicator is constructed of metal, wood, plastic and combinations thereof.

9. An emergency indicator for enabling emergency personnel to locate the site of an emergency situation, comprising:
a frame comprising a first support member, a second support member, and an upper cross member, the first support member having a first end and a second end and the second support member having a first end and a second end, the first and second support members being spatially disposed and substantially vertically extending such that the second ends of the first and second support members are positionable in the ground for supporting the emergency indicator in a stable position, the upper cross member having a first end and a second end wherein the first end of the upper cross member is connected to the first end of the first support member and the second end of the upper cross member is connected to the first end of the second support member; and
a display panel having a front surface with an indicia indicative of an emergency situation and an indicia indicative of the location of the emergency situation displayed thereon, the indicia being of sufficient size to be visible from a distance, the display panel having a substantially inverted T-shape and a first side, a second side, an upper end and a lower end, the first side of the display panel connected to the first support member of the frame, the second side of the display panel connected to the second support member, and the upper end of the display panel connected to the upper cross member of the frame such that the display panel is supported in a stable condition relative to the frame.

10. The emergency indicator of claim 9 wherein the frame further comprises a lower cross member having a first end and a second end, the first end is connected to the first support member and the second end is connected to the second support member, and the lower cross member is connected to the lower end of the display panel thereby providing further stability to the display panel.

11. The emergency indicator of claim 9 wherein the indicia indicative of the emergency and the indicia indicative of the location of the emergency are formed by stickers selectively applied to the display panel.

12. The emergency indicator of claim 9 wherein the indicia indicative of the emergency and the indicia indicative of the residence or business are constructed of a reflective material.

13. The emergency indicator of claim 9 wherein the indicia indicative of the emergency is 911.

14. The emergency indicator of claim 9 wherein the indicia indicative of the location of the emergency situation is an address or name of such site.

15. The emergency indicator of claim 1 wherein the emergency indicator is constructed of metal, wood, plastic and combinations thereof.

16. A method for identifying the location of an emergency situation, comprising:
providing an emergency indicator comprising:
a frame having a lower end and an upper end, the lower end adapted to be disposed in the ground so as to support the frame in a substantially upright position, the upper end of the frame defining a panel receiving space; and
a display panel positioned in the panel receiving space and connected to the frame, the display panel having an upper display area and a lower display area, the upper display area having an indicia indicative of an emergency situation displayed on at least one surface thereof, and the lower display area having an indicia indicative of the location of the emergency situation displayed in conjunction with the indicia displayed on the upper display area; and
inserting the lower end of the frame into the ground at a location where the indicia of the upper display area and the indicia of the lower display area are visible to emergency personnel upon emergency personnel being informed that a emergency exists at the location designated by the emergency indicator.

17. The method of claim 16 further comprising:
storing the emergency indicator at a first location; and
moving the emergency indicator to the location where the indicia is visible to emergency personnel proximate in time to informing emergency personnel of the emergency situation.

18. The method of claim 17 further comprising returning the emergency indicator to the storage location upon the conclusion of the emergency situation.
